(19) United States
(12) Patent Application Publication
(10) Pub. No.: US 2024/0236165 A1
(43) Pub. Date: Jul. 11, 2024

(54) METHOD AND APPARATUS FOR SIGNALING PRESELECTION WITH EXTENSIBLE MULTIPLEXING INSTRUCTIONS

(71) Applicant: Tencent America LLC, Palo Alto, CA (US)

(72) Inventor: Iraj SODAGAR, Los Angeles, CA (US)

(73) Assignee: Tenceent America LLC, Palo Alto, CA (US)

(21) Appl. No.: 18/408,960

(22) Filed: Jan. 10, 2024

Related U.S. Application Data
(60) Provisional application No. 63/438,485, filed on Jan. 11, 2023.

(51) Int. Cl. H04L 65/65; H04L 65/61

(52) U.S. Cl. CPC H04L 65/65; H04L 65/61

(57) ABSTRACT

A method of signaling extensible multiplexing instructions in dynamic adaptive streaming over http (DASH), the method includes: receiving a plurality of streams comprising video data or audio data; receiving a preselection element that comprises a first attribute having a predetermined value that indicates the preselection element includes a second attribute that includes a descriptor that identifies a multiplexing scheme via a unique identifier, wherein the descriptor includes a value with one or more instructions for multiplexing the plurality of streams; and transmitting the plurality of streams and the preselection element to an application that multiplexes the plurality of streams according to the one or more multiplexing instructions.

### CROSS-REFERENCE TO RELATED APPLICATION

This application claims priority from U.S. Provisional Application No. 63/438,485 filed on Jan. 11, 2023, and U.S. Provisional Application No. 63/438,482 filed on Jan. 11, 2023, the disclosures of each of which are incorporated herein by reference in their entirety.

### FIELD

The disclosure generally relates to signaling preselection with extensible multiplexing instructions.

### BACKGROUND

The Dynamic Adaptive Streaming over HTTP (DASH) standard is widely used for media content streaming. Preselection signaling provides a method for grouping multiple tracks together and providing information about the group of these tracks to the player. The player may retrieve a subset of these tracks, multiplex them together and feed the multiplexed stream to a decoder. One use case of this method is delivered object-based audio where the player can combine various objects and create a new audio experience.

The current method in DASH has a limited set of choices of multiplexing the

preselected tracks. The choices are designed specifically for object based audio and if a new codec is used, the multiplexing methods may not be suitable for that codec.

The ISO base media file format (ISOBMFF) standard is also another widely used media file format. Preselection signaling provides a method for grouping multiple tracks together and providing information about the group of these tracks to the player. The player may retrieve a subset of these tracks, multiplex them together and feed the multiplexed stream to a decoder. One use case of this method is delivered object-based audio where the player can combine various objects and create a new audio experience.

However, the current method in ISOBMFF also has a limited set of choices for multiplexing the preselected tracks. The choices are designed specifically for object-based audio and if a new codec is used, the multiplexing methods may not be suitable for that codec.

### SUMMARY

According to one or more embodiments, a method of signaling extensible multiplexing instructions in dynamic adaptive streaming over http (DASH), the method comprises: receiving a plurality of streams comprising video data or audio data; receiving a preselection element that comprises a first attribute having a predetermined value that indicates the preselection element includes a second attribute that includes a descriptor that identifies a multiplexing scheme via a unique identifier, wherein the descriptor includes a value with one or more instructions for multiplexing the plurality of streams; and transmitting the plurality of streams and the preselection element to an application that multiplexes the plurality of streams according to the one or more multiplexing instructions.

According to one or more embodiments, a method of signaling extensible multiplexing instructions in ISO base media file format (ISOBMFF) comprises receiving a plurality of streams comprising video data or audio data; receiving an ISOBMFF preselection processing box that comprises a flag having a value that indicates a descriptor that identifies a multiplexing scheme via a unique identifier, wherein the descriptor comprises a value that includes one or more multiplexing instructions for multiplexing the plurality of streams; and transmitting the plurality of streams and the preselection processing box to an application that multiplexes the plurality of streams according to the one or more multiplexing instructions.

According to one or more embodiments, an apparatus for signaling extensible multiplexing instructions in dynamic adaptive streaming over http (DASH), comprises: at least one memory configured to store program code; and at least one processor configured to read the program code and operate as instructed by the program code, the program code including: first receiving code configured to cause the at least one processor to receive a plurality of streams comprising video data or audio data; second receiving code configured to cause the at least one processor to receive a preselection element that comprises a first attribute having a predetermined value that indicates the preselection element includes a second attribute that includes a descriptor that identifies a multiplexing scheme via a unique identifier, wherein the descriptor includes a value with one or more instructions for multiplexing the plurality of streams; and transmitting code configured to cause the at least one processor to transmit plurality of streams and the preselection element to an application that multiplexes the plurality of streams according to the one or more multiplexing instructions.

According to one or more embodiments, an apparatus of signaling extensible multiplexing instructions in ISO base media file format (ISOBMFF), the apparatus comprising: at least one memory configured to store program code; and at least one processor configured to read the program code and operate as instructed by the program code, the program code including: first receiving code configured to cause the at least one processor to receive a plurality of streams comprising video data or audio data; second receiving code configured to cause the at least one processor to receive an ISOBMFF preselection processing box that comprises a flag having a value that indicates a descriptor that identifies a multiplexing scheme via a unique identifier, wherein the descriptor comprises a value that includes one or more multiplexing instructions for multiplexing the plurality of streams; and transmitting code configured to cause the at least one processor to transmit the plurality of streams and the preselection processing box to an application that multiplexes the plurality of streams according to the one or more multiplexing instructions.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is a block diagram of an example client architecture for processing a DASH element.

FIG. 4 is a flowchart of an example process of signaling extensible multiplexing instructions in DASH.

FIG. 5 is a block diagram of an example architecture for processing ISOBMFF.

FIG. 6 is a flowchart of an example process of signaling extensible multiplexing in ISOBMFF.

### DETAILED DESCRIPTION

The following detailed description of example embodiments refers to the

accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

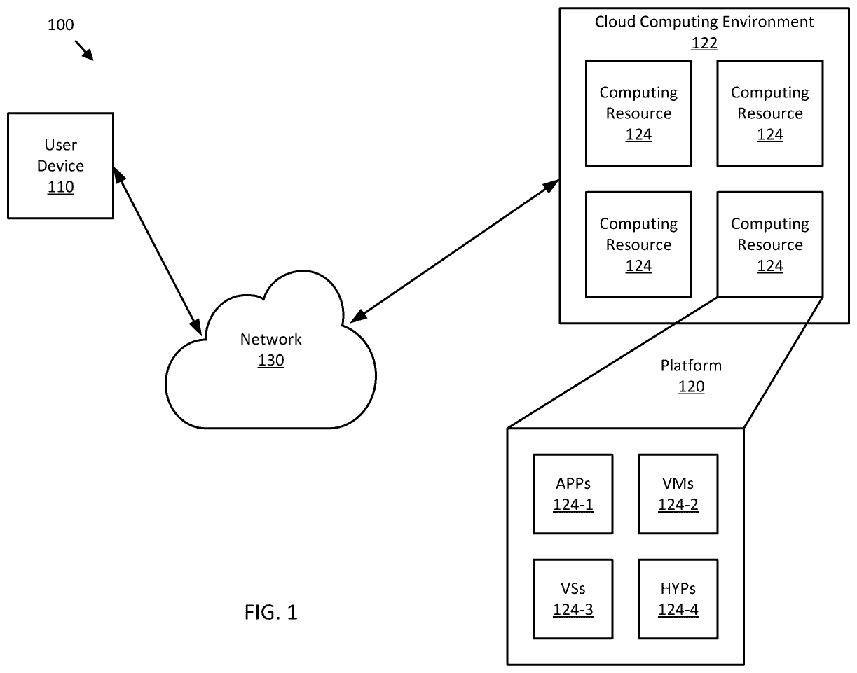

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

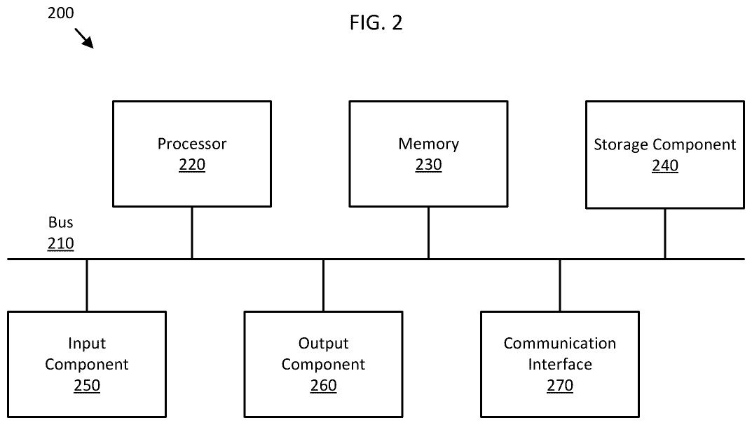

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

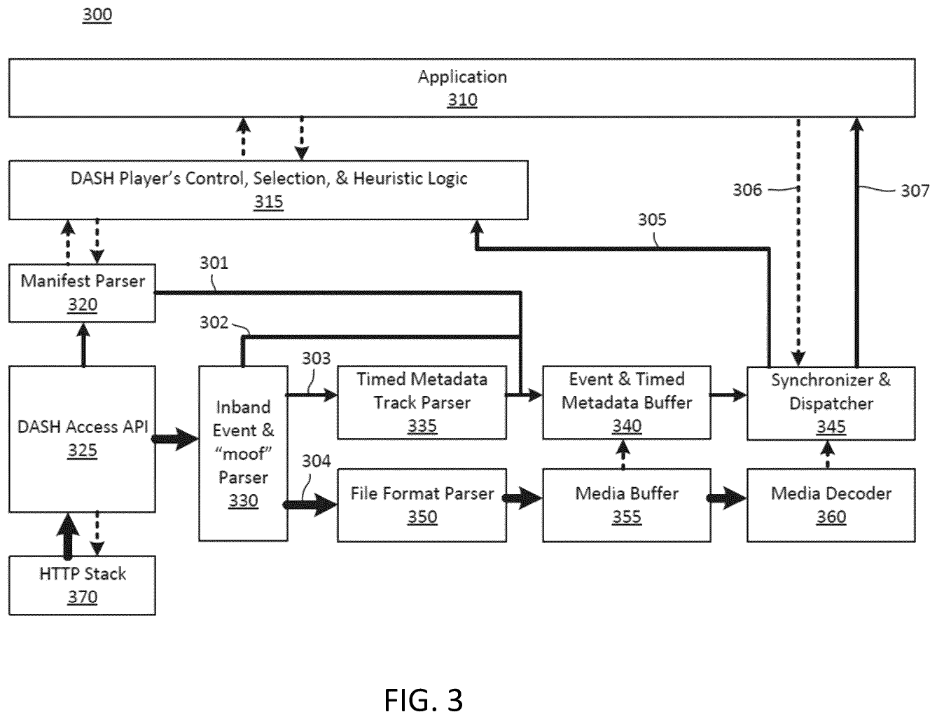

FIG. 3 illustrates an example DASH client 300 that is configured to process Media Presentation Description (MPD) events 301, inband events 302, and sparse timed metadata track events, according to embodiments of the present disclosure. The DASH client 300 can also be used for processing Common Media Application Format (CMAF) events. According to an embodiment, the DASH client 300 may be implemented by the user device 100 of FIG. 1.

Events may be provided in order to signal aperiodic information to the DASH client 300 or to an application. Events may be timed (e.g. each event starts at a specific media presentation time and may have a duration). Events may include DASH specific signaling or application-specific events. DASH events may be identified by scheme identifiers. For application specific events, a scheme identifier may identify the application such that the DASH client 300 can forward the event to the proper application.

As shown in FIG. 3, the DASH client 300 may include an application 310, a DASH player's control, selection, & heuristic logic 315, a manifest parser 320, a DASH access API 325, an inband event & “moof”' (movie fragment box) parser 330, a timed metadata track parser 335, an event & timed metadata buffer 340, a synchronizer & dispatcher 345, a file format parser 350, a media buffer 355, a media decoder 360, and an HTTP stack 370.

In FIG. 3, the broken lines represent control and/or synchronization; the regular, solid lines represent event and/or timed metadata flow; and the bold, solid lines represent media data flow. The control and/or synchronization may include, for example, a subscription function 306 and an event/metadata API 307. The event and/or timed metadata flow may include, for example, the MPD events 301, the inband events 302, the timed metadata 303, and the DASH events 305. The media data flow may include, for example, media segments 304.

The DASH client 300 may receive a manifest, such as MPDs, and may process them. The manifest may describe a combination and synchronization of independently packaged CMAF tracks grouped in CMAF switching sets and selection sets to form a synchronized multimedia presentation. The manifest may provide the DASH client 300 with information to select, initialize, start align, and synchronize the CMAF track(s) to be played, and identify CMAF media objects (e.g. CMAF headers, CMAF chunks, and CMAF fragments) as resources to access and to possibly download them. CMAF tracks and CMAF fragments may contain sufficient information to enable decryption, decoding, and presentation scheduling. The manifest can also provide information on delivery protocol, network management, authorization, license acquisition, etc., in addition to resource identification and presentation description. The manifest can also signal that tracks conform to a CMAF media profile.

For reference, a CMAF fragment may be a media object that is encoded and decoded. A CMAF fragment may include one or more pairs of a movie fragment box ('moof') and a media data box ('mdat'). Each pair of ‘moof’ and ‘mdat’ may be referred to as a CMAF chunk, and each CMAF chunk may contain a consecutive subset of media samples belonging to a CMAF fragment.

A CMAF track may be a continuous sequence of one or more CMAF fragments in presentation order conforming to a CMAF media profile, and an associated CMAF header. The CMAF header may contain a MovieBox that is sufficient to process and present all CMAF fragments in the CMAF track. A CMAF track may be produced by an encoder and an ISOBMFF file packager, but may be made to be accessible in the form of CMAF addressable media objects that can be references as resources defined by an external media application specification.

The DASH client 300 may request media segments based on described addresses in the manifest. The manifest may also describe metadata tracks. The DASH client 300 can also access the segment of metadata tracks, parse them, and send them to the application.

Also, of addresses for media segments, a DASH manifest may provide addressed for Index segments. Each index segment may provide information about one segment duration and size. A Representation Index may provide the index information for all segments of a given representation.

According to embodiments, the manifest parser 320 may parse MPD events 301 from the manifest, and append them to the event & timed metadata buffer 340. Based on the MPD, the DASH client 300 may manage the fetching and parsing of Segments from the HTTP stack 370. The parsing of the Segments may be performed by the inband event & “moof” parser 330. The inband event & “moof” parser may parse media segments 304 from the Segments before appending them to the media buffer 355. The parsing by the inband event & “moof” parser 330 may also include parsing inband events 302 and timed metadata 303 (e.g., timed metadata tracks) from the Segments. Also, the timed metadata track parser 335 may parse and append high-level boxes such as event message boxes of the timed meta data 303 and event message instance boxes of the timed meta data 303 to the event & timed metadata buffer 340.

The event & timed metadata buffer 340 may pass the events and timed metadata samples to the synchronizer & dispatcher 345, which may be referred to as an event & timed metadata synchronizer & dispatcher function.

The synchronizer & dispatcher 345 may dispatch DASH client 300 specific events to the DASH player's control, selection, & heuristic logic 315. If the application 310 is subscribed to a specific event(s) and/or timed metadata stream(s), the synchronizer & dispatcher 345 may dispatch the corresponding event instances and/or timed metadata samples to the application 310 via the event/metadata API 307.

As illustrated in FIG. 3, the client requests the media segments based on the described addresses in the manifest, where the manifest provides a description of the tracks. The relationship between tracks may be described using a preselection element in a MPD for the object-based content streaming. However, the current design defines explicit multiplexing schemes for the preselection, therefore, is limited.

Embodiments of the present disclosure are directed to custom signaling of the multiplex schemes in the preselection element. Instead of using specific predetermined values for @order, the embodiments define a new value that can carry additional information for multiplexing.

Table 1 illustrates example semantics of a preselection element in DASH.

| Element or Attribute Name | Use | Description |
|---|---|---|
| Preselection | | |
| @id | OD | specifies the id of the Preselection. This |
| | default = 1 | shall be unique within one Period. |
| @preselectionComponents | M | specifies the ids of the contained |
| | | Adaptation Sets or Content Components |
| | | that belong to this Preselection as white |
| | | space separated list in processing order. |
| | | The first id defines the Main Adaptation |
| | | Set. |
| @lang | O | same semantics for @lang attribute. |
| @order | OD | Specifies the conformance rules for |
| | Default: | Representations in Adaptation Sets within |
| | ‘undefined’ | the Preselection. |
| | | When set to ‘undefined’, the Preselection |
| | | follows the conformance rules for Multi- |
| | | Segment Tracks. |
| | | When set to ‘time-ordered’, the |
| | | Preselection follows the conformance rules |
| | | for Time-Ordered Segment Tracks. |
| | | When set to ‘fully-ordered’, the |
| | | Preselection follows the conformance rules |
| | | for Fully-Ordered Segment Tracks in |
| | | subclause. In this case, order in the |
| | | @preselectionComponents attribute |
| | | specifies the component order. |
| | | When set to ‘descriptive’, the |
| | | Preselection follows the conformance |
| | | rule defined by the description with |
| | | @id = ‘descriptive’ in this Preselection |
| | | element. |
| Accessibility | 0 . . . N | specifies information about accessibility |
| | | scheme. |
| Role | 0 . . . N | specifies information on role annotation |
| | | scheme. |
| Rating | 0 . . . N | specifies information on rating scheme. |
| Viewpoint | 0 . . . N | specifies information on viewpoint |
| | | annotation scheme. |
| CommonAttributesElements | — | specifies the common attributes and |
| | | elements (attributes and elements from |
| | | base type RepresentationBaseType). |

Key
For attributes: M = mandatory, O = Optional, OD = optional with default value, CM = conditionally mandatory
For elements: <minOccurs> . . . <maxOccurs> (N = unbounded)
Elements are bold; attributes are non-bold and preceded with an @.

According to one or more embodiments, the preselection element in DASH includes a new descriptor scheme with the following properties. In one or more examples, the attribute @schemeIdUri may be defined by the owner of the scheme. In one or more examples, the attribute @id=‘descriptive’ may be used to signal that this descriptor contains bitstream manipulation and multiplexing instruction for the preselection tracks. In one or more examples, the attribute @value contains one or more multiplexing instructions.

In one or more examples, in order to use this descriptor, an essential or supplemental descriptor is added to the preselection element with @id=‘descriptive’. In one or more examples, only one descriptor with such @id value is allowed in the preselection. The descriptor's @schemeIdUri may include a URI of the multiplexed scheme, and therefore, is uniquely identifiable by the player. The @value includes the multiplex instruction for the player.

The embodiments of the present disclosure use an extensible method for providing multiplexing instruction of preselected tracks in DASH streaming. The content author may define his/her own instructions for multiplexing and include them in the manifest. If the client recognizes the scheme id, then the client reads the instructions and follows them for multiplexing the preselected stream. Furthermore, the content author may define whether these instructions are essential (e.g., must be followed) or recommended by using one of two essential or supplemental property descriptors in DASH.

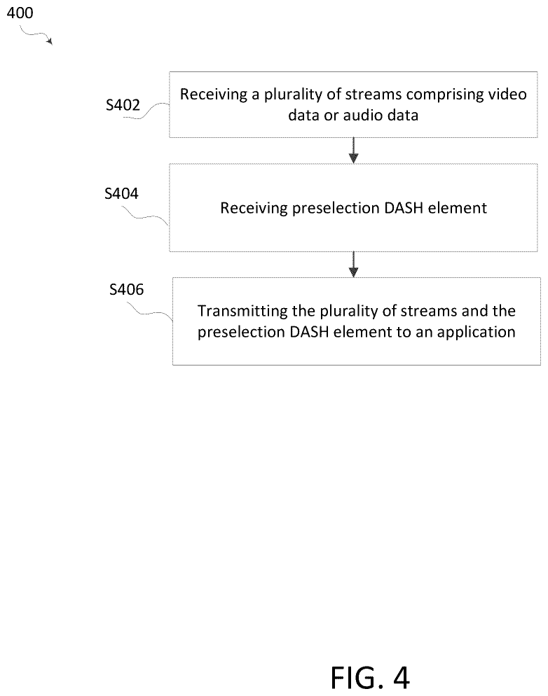

FIG. 4 illustrates a flowchart of an example process 400 of signaling extensible multiplexing instructions in DASH. The process 400 may be performed by processor 220 (FIG. 2) operating as a DASH access client. In one or more examples, the process 400 may be performed by the processor 220 operating as the DASH player control 315.

The process may start at operation S402 where a plurality of streams comprising video or audio data are received. The process proceeds to operation S404 where a preselection DASH element is received. The preselection DASH element may include the elements and/or attributes illustrated in table 1. When the @order attribute has the ‘descriptive’ value, the preselection includes a descriptor that identifies a multiplexing scheme (e.g., @order) and includes a value (e.g., @value) with one or more instructions for multiplexing the plurality of streams.

The process proceeds to operation S406 where the plurality of streams and the preselection DASH element are transmitted to an application that multiplexes the plurality of streams in accordance with the one or more instructions.

According to one or more embodiments, a method of signaling extensible custom multiplexing instructions for mixing the preselected tracks in DASH is performed, where instead of using a predefined multiplex scheme, the scheme is identified using a descriptor having a unique identifier, where the unique identifier defines the scheme and the descriptor's value contains the multiplexing instruction, which is forwarded to the player by the DASH access client. The DASH access client does not need to know the meaning of the instructions (e.g., the multiplexing instructions are not interpreted by the DASH access client prior to forwarding to the application). The descriptor @id may be used to signal the use of the generic descriptor for this purpose, where the essentiality (required to be processed this way) or optionality (recommended to be processed this way) may be signaled with the use of essential or supplemental descriptor.

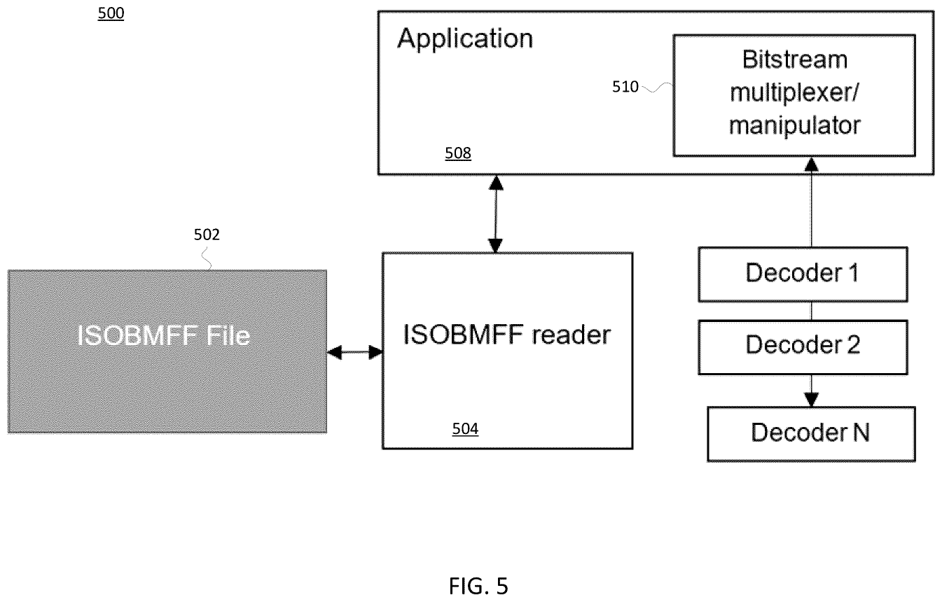

FIG. 5 illustrates an example system 500 for processing ISOBMFF. The system 500 includes a ISOBMFF reader 504 the processes a ISOBMFF file 502 and forwards the file to an Application 508. In this regard, the ISOBMFF reader 504 reads the ISOBMFF file 502 and plays the file. The Application 508 uses the ISOBMFF reader to access the ISOBMFF file and the file's information. The Application 508 retrieves parts of some tracks based on the metadata retrieved from the ISOBMFF file. Based on metadata information provided to the Application 508, the Application 508 chooses to retrieve a subset of tracks and provide them to the decoders (e.g., Decoder 1 . . . Decoder N). The metadata also includes the bitstream multiplexing/manipulation 510 that the Application 508 uses to apply to the retrieved streams before providing them to the decoders.

However, in the current design of ISOBMFF, the multiplexing schemes are fixed to a few determined choices. These limited choices poses problems since different codecs and applications may need different multiplex schemes, and based on the current design, there is no way to customize or extend the existing choices.

Embodiments of the present disclosure are directed to custom signaling of the multiplex schemes in a preselection processing box of ISOBMFF. In this regard, instead of using specific predetermined values using track_order and sample_merge_flag, the embodiments of the present disclosure use URI and a string to signal custom instructions.

According to one or more embodiments, the preselection processing box includes the following properties:

Box Type: ‘prsp’

Container: PreselectionGroupBox

Mandatory: No

Quantity: Zero or one

In one or more examples, this box contains information about how the tracks contributing to the preselection may be processed. Media type specific boxes may be used to describe further processing.

According to one or more embodiments, the preselection processing box may have the following syntax:

```
aligned(8) class PreselectionProcessingBox
  extends FullBox(‘prsp’, version=0, flags ){
  unsigned int(8) track_order;
  unsigned int(1) sample_merge_flag;
  unsigned int(7) reserved;
  if (sample_merge_flag == 2) {
    utf8string schemeURI;
    utf8string value;
  }
  // further attributes and Boxes defining additional processing of
  // the track contributing to the preselection
}
```

In one or more examples, a track_order defines the order of this track relative to other tracks in the preselection as described below.

In one or more examples, sample_merge_flag may be set to 1 to indicate that this track is enabled to be merged with another track as described below. If this flag is equal to 2, then the multiplexing scheme is defined by the parameters schemeURI and value.

In one or more examples, the parameter schemeURI declares the identifier of the multiplex scheme. In one or more examples, the parameter value defines the multiplexing instruction. The owner of schemURI may define the format of this string and its meaning.

In one or more examples, a sample entry specific specification may require the tracks for a preselection to be provided to the respective decoder instances in a specific order. Since other means, such as the track_id, are not reliable for this purpose, the track_order may be used to order tracks in a preselection relative to each other. A lower value of track_order may indicate that at a given decoding time, the sample of the containing track is provided to the decoder before the sample with the same given decoding time of other tracks with higher number. If two tracks in a preselection have their track_order set to the same value, or if the preselection processing box is absent for at least one of the tracks, the order of these tracks is not relevant for the preselection, and the samples with a particular decoding time for these two tracks may be provided to the decoder in any order.

In one or more examples, a merge group may be defined as a group of tracks, sorted according to track_order, where one track with the sample_merge_flag set to 0 may be followed by a group of consecutive tracks with the sample_merge_flag set to 1. In one or more examples, all tracks of a merge group shall be of the same media type and shall have all samples decoding-time-aligned.

The embodiments of the present disclosure use an extensible method for providing multiplexing instruction of preselected tracks in ISOBMFF. The content author may define his/her own instructions for multiplexing and include them in the preselection box. If the application recognizes the scheme id, then the application reads the instructions and follows these for multiplexing the preselected stream.

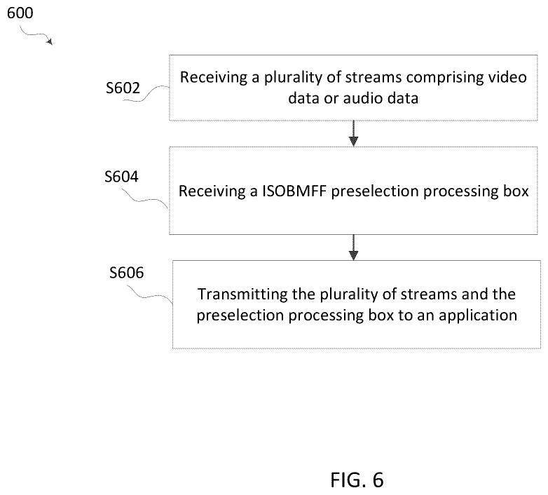

FIG. 6 is a flowchart of an example process 600 of signaling extensible multiplexing in ISOBMFF. The process 600 may be performed by the processor 220 (FIG. 2) operating as the ISOBMFF file reader 504.

The process may start at operation S602 where a plurality of streams comprising video data or audio data is received. The process proceeds to operation S604 where a ISOBMFF preselection processing box is received. The ISOBMFF processing box may be included in a file such as the ISOBMFF file 502. The ISOBMFF processing box may include a flag having a value that indicates a descriptor that identifies a multiplexing scheme via a unique identifier. For example, the flag may correspond to the sample_merge_flag. When sample_merge_flag is set to a predetermined value (e.g., 2), the schemeURI may be used to declare the identifier of a multiplexing scheme, and the parameter value includes one or more multiplexing instructions.

The process proceeds to operation S606 where the plurality of streams and the preselection processing box are transmitted to an application (e.g., Application 508) that multiplexes the plurality of streams according to the one or more multiplexing instructions.

According to one or more embodiments, a method of signaling extensible custom multiplexing instructions for mixing the preselected tracks in ISOBMFF is performed, where instead of using a predefined multiplex scheme, the scheme is identified using a descriptor, wherein the unique identifier defines the scheme and the descriptor's value contains the multiplexing instruction, which is forwarded to the player by the ISOBMFF file reader, and ISOBMFF file reader does not need to know the meaning of it (e.g., the ISOBMFF file reader does not interpret the instruction before forwarding to an application).

The proposed methods disclosed herein may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise. The above disclosure also encompasses the embodiments listed below:

(1) A method of signaling extensible multiplexing instructions in dynamic adaptive streaming over http (DASH), the method comprising: receiving a plurality of streams comprising video data or audio data; receiving a preselection element that comprises a first attribute having a predetermined value that indicates the preselection element includes a second attribute that includes a descriptor that identifies a multiplexing scheme via a unique identifier, in which the descriptor includes a value with one or more instructions for multiplexing the plurality of streams; and transmitting the plurality of streams and the preselection element to an application that multiplexes the plurality of streams according to the one or more multiplexing instructions.

(2) The method according to feature (1), in which the preselection element includes an essential or supplemental descriptor that indicates whether the multiplexing scheme specified in the second field is required or optional.

(3) The method according to feature (1) or (2), in which the second attribute is an identifier attribute that defines the multiplexing scheme.

(4) The method according to any one of features (1)-(3), in which the second attribute includes a uniform resource identifier that identifies the multiplexing scheme.

(5) The method according to any one of features (1)-(4), in which the first attribute is an @order attribute of the preselection element.

(6) The method according to feature (5), in which the @order attribute set to a value ‘descriptive’ indicates that the multiplexing scheme identified in the second attribute is used to multiplex the plurality of streams.

(7) The method according to any one of features (1)-(6), in which the one or more multiplexing instructions are not interpreted prior to transmission to the application.

(8) A method of signaling extensible multiplexing instructions in ISO base media file format (ISOBMFF), the method comprising: receiving a plurality of streams comprising video data or audio data; receiving an ISOBMFF preselection processing box that comprises a flag having a value that indicates a descriptor that identifies a multiplexing scheme via a unique identifier, in which the descriptor comprises a value that includes one or more multiplexing instructions for multiplexing the plurality of streams; and transmitting the plurality of streams and the preselection processing box to an application that multiplexes the plurality of streams according to the one or more multiplexing instructions.

(9) The method according to feature (8), in which the flag is a sample_merge_flag.

(10) The method according to feature (8) or (9), in which the unique identifier is a uniform resource identifier (URI).

(11) The method according to any one of features (8)-(10), in which the one or more multiplexing instructions are not interpreted prior to transmission to the application.

(12) An apparatus for signaling extensible multiplexing instructions in dynamic adaptive streaming over http (DASH), the apparatus comprising: at least one memory configured to store program code; and at least one processor configured to read the program code and operate as instructed by the program code, the program code including first receiving code configured to cause the at least one processor to receive a plurality of streams comprising video data or audio data; second receiving code configured to cause the at least one processor to receive a preselection element that comprises a first attribute having a predetermined value that indicates the preselection element includes a second attribute that includes a descriptor that identifies a multiplexing scheme via a unique identifier, in which the descriptor includes a value with one or more instructions for multiplexing the plurality of streams; and transmitting code configured to cause the at least one processor to transmit plurality of streams and the preselection element to an application that multiplexes the plurality of streams according to the one or more multiplexing instructions.

(13) The apparatus according to feature (12), in which the preselection element includes an essential or supplemental descriptor that indicates whether the multiplexing scheme specified in the second field is required or optional.

(14) The apparatus according to feature (12) or (13), in which the second attribute is an identifier attribute that defines the multiplexing scheme.

(15) The apparatus according to any one of features (12)-(14), in which the second attribute includes a uniform resource identifier that identifies the multiplexing scheme.

(16) The apparatus according to any one of features (12)-(15), in which the first attribute is an @order attribute of the preselection element.

(17) The apparatus according to feature (16), in which the @order attribute set to a value ‘descriptive’ indicates that the multiplexing scheme identified in the second attribute is used to multiplex the plurality of streams.

(18) The apparatus according to any one of features (12)-(17), in which the one or more multiplexing instructions are not interpreted prior to transmission to the application.

(19) An apparatus of signaling extensible multiplexing instructions in ISO base media file format (ISOBMFF), the apparatus comprising: at least one memory configured to store program code; and at least one processor configured to read the program code and operate as instructed by the program code, the program code including: first receiving code configured to cause the at least one processor to receive a plurality of streams comprising video data or audio data; second receiving code configured to cause the at least one processor to receive an ISOBMFF preselection processing box that comprises a flag having a value that indicates a descriptor that identifies a multiplexing scheme via a unique identifier, in which the descriptor comprises a value that includes one or more multiplexing instructions for multiplexing the plurality of streams; and transmitting code configured to cause the at least one processor to transmit the plurality of streams and the preselection processing box to an application that multiplexes the plurality of streams according to the one or more multiplexing instructions.

(20) The apparatus according to feature (19), in which the flag is a sample_merge_flag.

What is claimed is:

1. A method of signaling extensible multiplexing instructions in dynamic adaptive streaming over http (DASH), the method comprising:
receiving a plurality of streams comprising video data or audio data;
receiving a preselection element that comprises a first attribute having a predetermined value that indicates the preselection element includes a second attribute that includes a descriptor that identifies a multiplexing scheme via a unique identifier, wherein the descriptor includes a value with one or more instructions for multiplexing the plurality of streams; and
transmitting the plurality of streams and the preselection element to an application that multiplexes the plurality of streams according to the one or more multiplexing instructions.

2. The method according to claim 1, wherein the preselection element includes an essential or supplemental descriptor that indicates whether the multiplexing scheme specified in the second field is required or optional.

3. The method according to claim 1, wherein the second attribute is an identifier attribute that defines the multiplexing scheme.

4. The method according to claim 1, wherein the second attribute includes a uniform resource identifier that identifies the multiplexing scheme.

5. The method according to claim 1, wherein the first attribute is an @order attribute of the preselection element.

6. The method according to claim 5, wherein the @order attribute set to a value ‘descriptive’ indicates that the multiplexing scheme identified in the second attribute is used to multiplex the plurality of streams.

7. The method according to claim 1, wherein the one or more multiplexing instructions are not interpreted prior to transmission to the application.

8. A method of signaling extensible multiplexing instructions in ISO base media file format (ISOBMFF), the method comprising:
receiving a plurality of streams comprising video data or audio data;
receiving an ISOBMFF preselection processing box that comprises a flag having a value that indicates a descriptor that identifies a multiplexing scheme via a unique identifier, wherein the descriptor comprises a value that includes one or more multiplexing instructions for multiplexing the plurality of streams; and
transmitting the plurality of streams and the preselection processing box to an application that multiplexes the plurality of streams according to the one or more multiplexing instructions.

9. The method according to claim 8, wherein the flag is a sample_merge_flag.

10. The method according to claim 8, wherein the unique identifier is a uniform resource identifier (URI).

11. The method according to claim 8, wherein the one or more multiplexing instructions are not interpreted prior to transmission to the application.

12. An apparatus for signaling extensible multiplexing instructions in dynamic adaptive streaming over http (DASH), the apparatus comprising:
at least one memory configured to store program code; and
at least one processor configured to read the program code and operate as instructed by the program code, the program code including:
first receiving code configured to cause the at least one processor to receive a plurality of streams comprising video data or audio data;
second receiving code configured to cause the at least one processor to receive a preselection element that comprises a first attribute having a predetermined value that indicates the preselection element includes a second attribute that includes a descriptor that identifies a multiplexing scheme via a unique identifier, wherein the descriptor includes a value with one or more instructions for multiplexing the plurality of streams; and
transmitting code configured to cause the at least one processor to transmit plurality of streams and the preselection element to an application that multiplexes the plurality of streams according to the one or more multiplexing instructions.

13. The apparatus according to claim 12, wherein the preselection element includes an essential or supplemental descriptor that indicates whether the multiplexing scheme specified in the second field is required or optional.

14. The apparatus according to claim 12, wherein the second attribute is an identifier attribute that defines the multiplexing scheme.

15. The apparatus according to claim 12, wherein the second attribute includes a uniform resource identifier that identifies the multiplexing scheme.

16. The apparatus according to claim 12, wherein the first attribute is an @order attribute of the preselection element.

17. The apparatus according to claim 16, wherein the @order attribute set to a value ‘descriptive’ indicates that the multiplexing scheme identified in the second attribute is used to multiplex the plurality of streams.

18. The apparatus according to claim 12, wherein the one or more multiplexing instructions are not interpreted prior to transmission to the application.

19. An apparatus of signaling extensible multiplexing instructions in ISO base media file format (ISOBMFF), the apparatus comprising:
at least one memory configured to store program code; and
at least one processor configured to read the program code and operate as instructed by the program code, the program code including:
first receiving code configured to cause the at least one processor to receive a plurality of streams comprising video data or audio data;
second receiving code configured to cause the at least one processor to receive an ISOBMFF preselection processing box that comprises a flag having a value that indicates a descriptor that identifies a multiplexing scheme via a unique identifier, wherein the descriptor comprises a value that includes one or more multiplexing instructions for multiplexing the plurality of streams; and
transmitting code configured to cause the at least one processor to transmit the plurality of streams and the preselection processing box to an application that multiplexes the plurality of streams according to the one or more multiplexing instructions.

20. The apparatus according to claim 19, wherein the flag is a sample_merge_flag.
